(19) United States
(12) Patent Application Publication
(10) Pub. No.: US 2012/0191544 A1
(43) Pub. Date: Jul. 26, 2012

(54) ARCHIVING AND RETRIEVING DATA RELATED TO A USER GOAL

(76) Inventor: Jason P. SILVESTRI, Mansfield, MA (US)

(21) Appl. No.: 13/187,097

(22) Filed: Jul. 20, 2011

Related U.S. Application Data
(60) Provisional application No. 61/366,043, filed on Jul. 20, 2010.

(51) Int. Cl. G06F 3/048; G06Q 30/02

(52) U.S. Cl. 705/14.66; 715/772

(57) ABSTRACT

A method and computer program product for archiving and retrieving data related to a users goals are described. Embodiments include receiving information related to the users goal, displaying a visual affirmation of the user's goal, receiving symbolualgraphic data, storing user data that includes the received information, the visual affirmation, and the symbolualgraphic data, for further action, and displaying a resource related to archiving the user's goal.

### CROSS REFERENCE TO RELATED APPLICATIONS

The present application claims priority to U.S. Provisional Patent application No. 61/366,043, filed Jul. 20, 2010, the entire content of which is incorporated herein by reference.

### BACKGROUND OF THE INVENTION

The present invention generally relates to methods for managing user goals, and, more particularly, to archiving and retrieving data related to a user's goals and provider resources.

Some methods do not provide an ability to archive user goals and provider resources in an effective and concurring manner or provide an effective mechanism of alerting the user with a specific need of a corresponding resource.

As can be seen, there is a need for an improved method that provides an effective mechanism of fixing a user's faults and achieving his dreams.

### SUMMARY OF THE INVENTION

In one aspect of the present invention, a method of archiving and retrieving data related to a user's goals by a computer system comprises receiving information related to the user's goal; displaying a visual affirmation of the user's goal; receiving symbolualgraphic data; storing user data for further action to an electronic data record, wherein the user data includes the received information, the visual affirmation, and the symbolualgraphic data; and displaying a resource, wherein the resource is related to achieving the user's goal.

In another aspect of the present invention, a computer program product for archiving and retrieving data related to a user's goals comprises a computer readable storage medium having computer readable program code embodied therewith, the computer readable program code comprising computer readable program code configured to instruct a computer system to receive a user's goal; present an affirmation of the user's goal; store symbolualgraphic data; store user data to a database; display a resource, wherein the resource is related to the user's goal; receive a commitment to provide the resource from a resource provider; provide contact information of the resource provider to the user; and provide a mechanism of sharing information of the resource provider to a second user

These and other features, aspects and advantages of the present invention will become better understood with reference to the following drawings, description and claims.

### BRIEF DESCRIPTION OF THE DRAWINGS

FIG. 1 is a process flow diagram of a method of archiving and retrieving data related to a user's goals according to an embodiment of the present invention;

FIG. 2 is diagram of an interface illustrating an aspect of the method of FIG. 1; and

FIG. 3 is diagram of an interface illustrating an aspect of the method of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method of archiving and retrieving data related to a user's goals, and alerting the user to resources committed by a resource provider that may be related to the user's goals.

As used herein, data may relate to goal data, task (e.g., sub-step) data, shared data, user data, resource provider data, and resource data. Data may include information related to the user's goals (e.g., dreams, tasks, and faults), the user (e.g., name, address, age, gender, id, place of business, and ethnic group), the user's notes, task information, security preferences, visual affirmation data, and symbolualgraphic data, for example.

Visual affirmation data may include a video, text, audio, image, graphic, artwork, illustration-based confirmation, assertion, verification, or reassurance that the user may visit or view to reinforce morale and to provide other stimulus. Symbolualgraphic data may include a symbolic representation of a text, image, graphic, artwork, or illustration-based element that may have a significant meaning to the user. The symbolualgraphic data may relate to the user's goal or goal data, and may reinforce achievement of the goal, improve morale, or provide other stimulus related to achieving the user's goal. A resource provider may be a user or third party (e.g., business, organization, consumer, or computer identity) that may provide a resource or service.

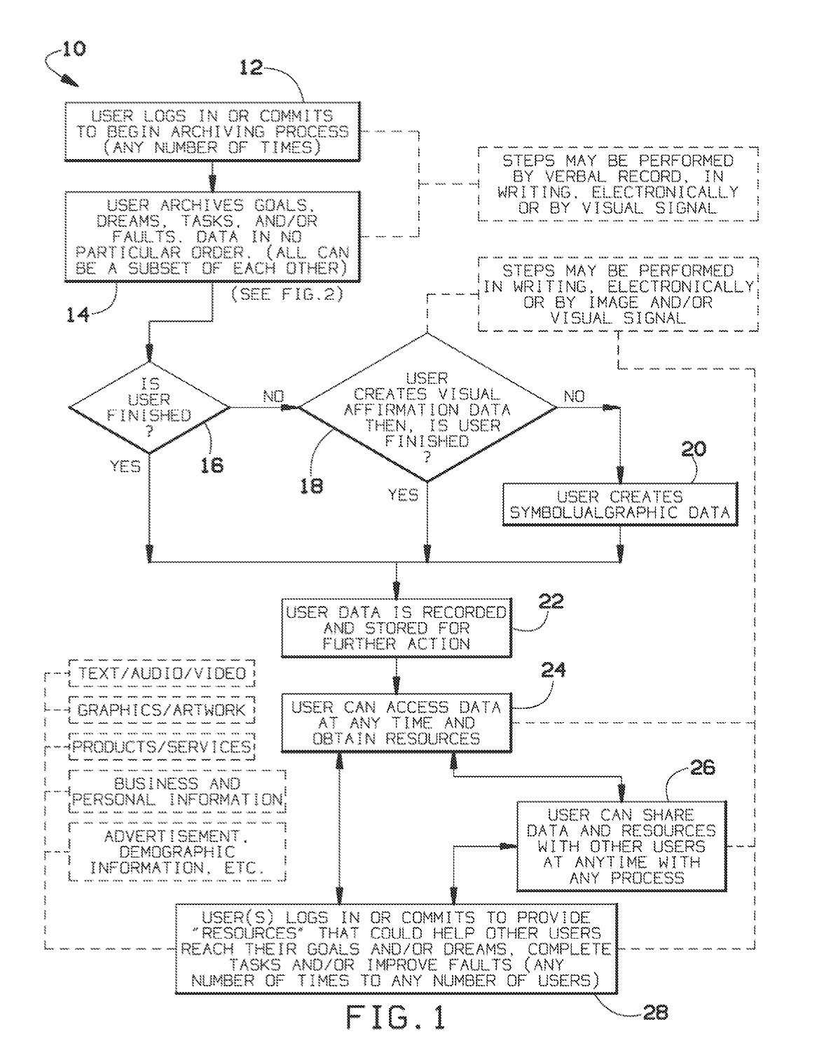

Referring to FIG. 1, a process flow diagram of a method 10 of archiving and retrieving data related to a users goals is shown according to an exemplary embodiment of the present invention. Method 10 may be implemented by a system that may include a computer system including hardware logic or software program code. The system may provide a login and a goal archiving option to a user (step 12), where the user may login and commit to beginning the goal archiving process. An interface may be presented to the user (step 14), where data related to a user goal and a related task may be entered and received by the system. The system may provide the user an option to complete and save the goal data (step 16), to a data record of an electronic data storage mechanism that may include a database, flat file, record, or other electronic data storage mechanism, for example. An interface may be provided whereby a visual affirmation may be created by the user that may relate to the user goal (step 18). The system may query or determine a resource provider that may relate to (e.g., through keyword or category) the user goal, and information (e.g., media, advertisement) related to the resource provider and services or resources provided thereby may be presented to the user. A mechanism may be provided for a user to create symbolualgraphic data that may be related to the goal data (step 20).

The goal data, visual affirmation data, and symbolualgraphic data may be saved to a storage mechanism (step 22). An interface for viewing and accessing the goal, visual affirmation, and symbolualgraphic data may be provided to the user (step 24). The system may determine a requirement that may be related to the user goal, and present or suggest a resource provider to fulfill the requirement (e.g., resource provider advertisement). A mechanism may be provided that may allow the user to share data related to a resource with other users (step 26). An interface for a login may be provided to a resource provider whereby a resource provider's information may be entered, a resource may be committed, or an advertisement or solicitation may be received (step 28).

The mechanism of sharing data may include methods of transmitting information known in the art including a written signal or an electronic signal (e.g., email, online interface, login system, audio recording, video recording), for example. According to some exemplary embodiments, aspects of the present invention may exploit features available on mobile devices, mobile applications, and cloud computing technologies. According to some exemplary embodiments, multiple users may collaborate and submit proposals to a resource provider for jointly using a resource for benefits including economies of scale, lot splitting, and collective bargaining, for example.

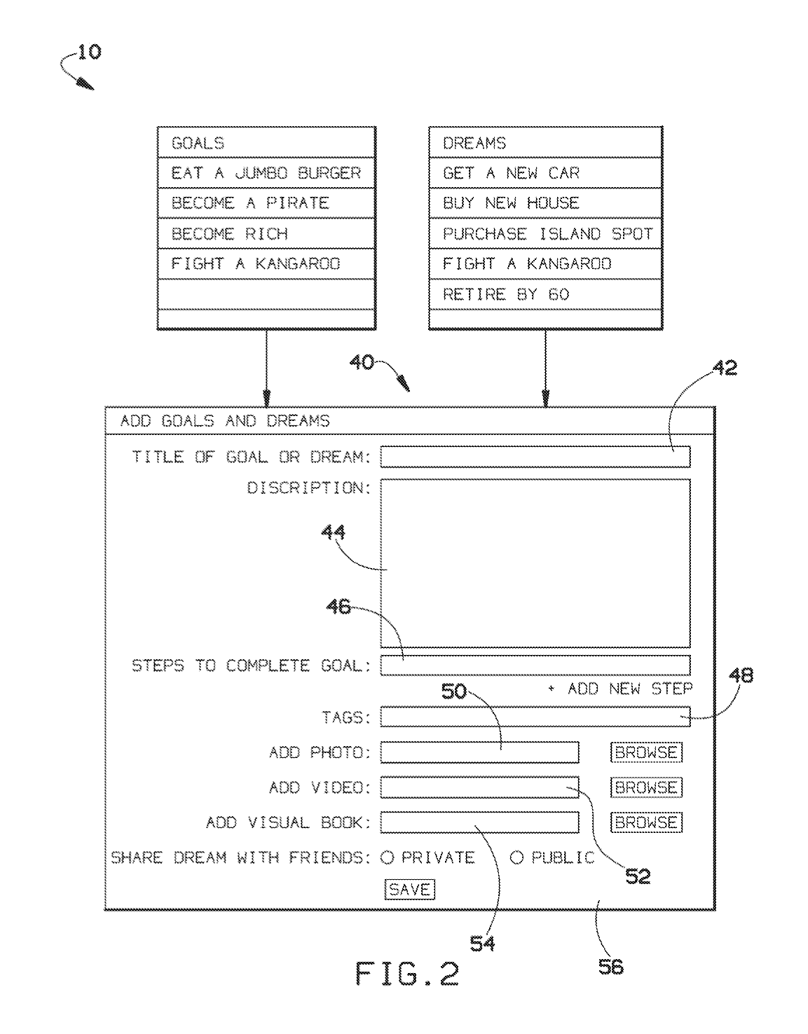

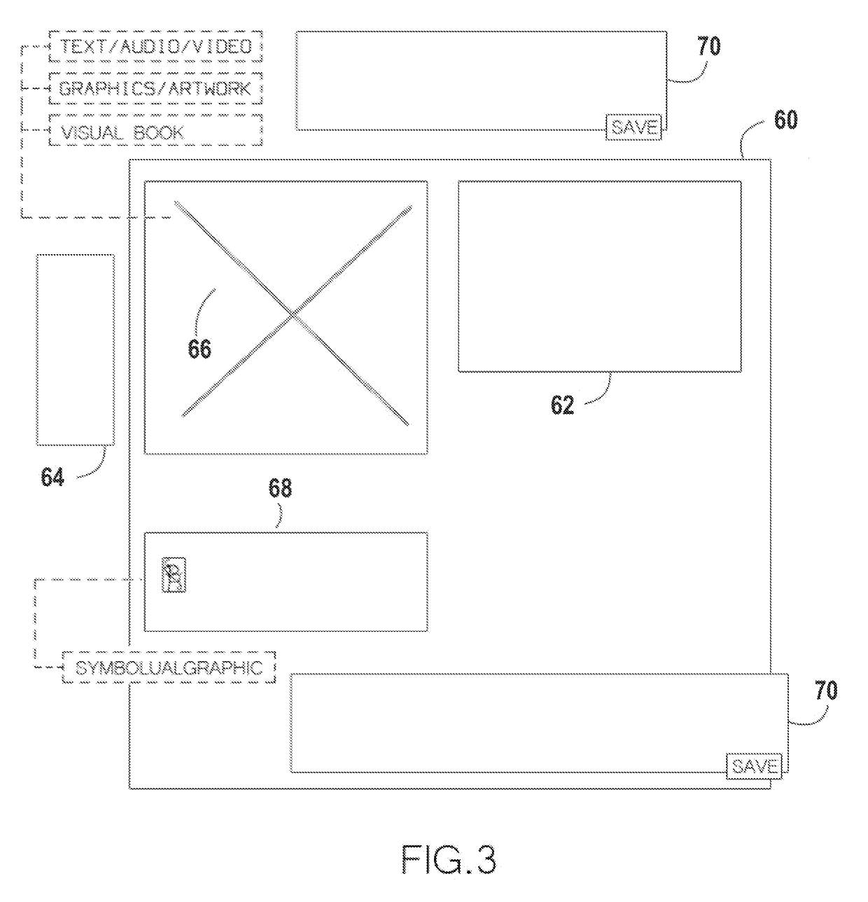

Referring now to FIGS. 2 and 3, interfaces 40 and 60 are shown respectively according to an exemplary embodiment of the present invention. Interface 40 may include fields or options for receiving a title of a goal or dream 42, a description 44, steps or tasks to complete the goal 46, tags related to the goal 48, a photo 50, a video 52, a visual book 54, and privacy settings 56, for example. According to some exemplary embodiments, the field or option including steps or tasks to complete the goal 46 may include an option to add an additional step or task. Interface 60 may include panels or forms where aspects of method 10 may be performed. A user goal panel 62 may display a user goal and allow entry or modification thereof. A toolkit panel 64 may aid the display or modification of the goal in goal panel 62. A visual affirmation panel 66 may display the visual affirmation related to the goal displayed in goal panel 62, and a symbolualgraphic panel 68 may display or allow modification of the symbolualgraphic data related to the goal displayed in goal panel 62. One or more resource panels 70 may display a resource provider, available resource, or advertisement, for example, that may correspond to the goal displayed in goal panel 62 or to a related task.

Aspects of method 10 may be implemented or invoked through interfaces 40, 60 or another interface or interactive presentation mechanism that may include a graphical user interface, a form, an application interface, an application programming interface (API), or other communication means that may be engaged by a user through direct interaction or through an application (e.g., web browser).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

Aspects of the present invention may take the form of a computer program product embodied in one or more computer readable medium(s) having computer readable program code embodied thereon. Any combination of one or more computer readable medium(s) may be utilized, including a computer readable signal medium or a computer readable storage medium.

Program code embodied on a computer readable medium may be transmitted using any appropriate medium, and may carrying out operations for aspects of the present invention. Program code may be written in any combination of one or more programming languages, including an object oriented programming language and conventional procedural programming languages. Program code may execute entirely on the user's computer, as a stand-alone software package, on a remote computer or server, as part of a monitor code, or any combination thereof. In some exemplary embodiments, the remote computer may be connected to the user's computer through any type of network, including a local area network, a wide area network, or the Internet.

It should be understood, of course, that the foregoing relates to exemplary embodiments of the invention and that modifications may be made without departing from the spirit and scope of the invention as set forth in the following claims.

What is claimed is:

1. A method of archiving and retrieving data related to a user's goal by a computer system, the method comprising:
receiving information related to the user's goal;
displaying a visual affirmation of the user's goal;
receiving symbolualgraphic data;
storing user data for further action to an electronic data record, wherein the user data includes the received information, the visual affirmation, and the symbolualgraphic data; and
displaying a resource, wherein the resource is related to achieving the user's goal.

2. The method of claim 1, further comprising:
receiving a commitment to provide the resource from a resource provider.

3. The method of claim 1, wherein displaying the visual affirmation includes:
determining an advertisement related to the user's goal; and
presenting the advertisement related to the user's goal.

4. The method of claim 1, wherein displaying the resource comprises:
determining a requirement related to the user's goal;
retrieving the resource from a database, wherein the resource corresponds to the determined requirement; and
providing contact information of a resource provider.

5. The method of claim 4, wherein the contact information includes at least one of personal information, business information, and advertisement information.

6. The method of claim 4, further comprising:
providing a mechanism of sharing information of the resource provider to a second user.

7. A computer program product for archiving and retrieving data related to a user's goals, the computer program product comprising:
a computer readable storage medium having computer readable program code embodied therewith, the computer readable program code comprising:
computer readable program code configured to instruct a computer system to:
receive a user's goal;
present an affirmation of the user's goal;
store symbolualgraphic data;
store user data to a database;
display a resource, wherein the resource is related to the user's goal;
receive a commitment to provide the resource from a resource provider;
provide contact information of the resource provider to the user; and
provide a mechanism of sharing information of the resource provider to a second user.

8. The computer program product of claim 7, wherein the computer readable program code is further configured to instruct the computer system to:
receive the affirmation of the user's goal, wherein the affirmation is chosen from a group consisting of an image, a sound recording, a text, and a video.

9. The computer program product of claim 8, wherein the computer readable program code is further configured to instruct the computer system to:
create the symbolualgraphic data, wherein the symbolualgraphic data is a symbolic representation of text elements of the user's goal.

10. The computer program product of claim 9, wherein the compute readable program code is further configured to instruct the computer system to:
determine a requirement related to the user's goal;
retrieve the resource that corresponds to the requirement.
